(19) United States
(12) Patent Application Publication
(10) Pub. No.: US 2025/0282121 A1
(43) Pub. Date: Sep. 11, 2025

(54) FLEXIBLE PLASTIC REVERSE-PRINTED PACKAGING COMPOSED OF POLYETHYLENE WITH HAZY POLYMER LAYER

(71) Applicant: POLYEXPERT INC., Laval (CA)

(72) Inventors: Pierre Sarazin, Laval (CA); Narges Emami, Laval (CA); Ebrahim Jalali Dil, Laval (CA); Laure Burguera, Laval (CA)

(73) Assignee: POLYEXPERT INC., Laval, QC (CA)

(21) Appl. No.: 19/072,034

(22) Filed: Mar. 6, 2025

(30) Foreign Application Priority Data
Mar. 6, 2024 (CA) 3231186

(51) Int. Cl. B32B 7/12; B32B 27/08; B32B 27/32; B32B 38/00

(52) U.S. Cl. CPC B32B 7/12; B32B 27/08; B32B 27/32; B32B 38/145; B32B 2250/02; B32B 2250/242; B32B 2305/70; B32B 2307/406; B32B 2307/41; B32B 2307/7244; B32B 2307/7376; B32B 2323/043; B32B 2323/046; B32B 2553/00

(57) ABSTRACT

The present description relates to the use of a hazy polymer layer composed of non-oriented HMW-HDPE in a reverse printing film that can be part of a PE-based flexible packaging material used for self-standing packages. The hazy polymer layer can facilitate an excellent matte finish and visibility of the print, for example, or can be part of a co-extruded printing film with skins that provide a glossy finish to the product while enabling good print visibility. The present technology can enable production of PE-based packaging facilitating plastic recycling.

### TECHNICAL FIELD

The field generally relates to flexible plastic packaging and more particularly to laminated packaging, such as stand-up pouches (SUPs), having polyethylene layers.

### BACKGROUND

Conventional flexible plastic packaging, such as SUPs, typically include a sealant layer and a printing film layer. The printing film is printed in reverse and laminated to the sealant layer after printing. The printing film is printed on the reverse side, so that the ink is sandwiched in the structure and the print is not altered during the useful life of the packaging. The sealant layer is often a polyethylene film manufactured by the blown film process, the attributes of which are to have good sealing performance, the general mechanical properties required for packaging, and surface properties enabling the film to be converted by lamination. The printing film is usually a very thin film (0.4 to 1 mil) with very good optical properties (e.g., clarity and gloss), a thermal resistance far superior to polyethylene, and a stiffness often characterized by a very high tensile or flexural modulus compared to the sealant layer. For example, oriented or non-oriented polypropylene (PP), polyethylene terephthalate (PET) and polyamide (PA) films are used as reverse printing films for flexible plastic packaging. However, the use of PP, PET or PA as a base material for printing films poses a major problem for the recyclability of packaging, so that recycled plastic becomes a raw material used in the production of new products. An alternative polymeric material to use for printing film is polyethylene (PE), but to closely resemble the materials traditionally used these polymers must be processed to enable orientation and thus provide the sought-after surface properties (e.g., high gloss and low haze) for printing and display of the printed images and the required high stiffness. The production of oriented polymers such as oriented PE requires specialized equipment and processing techniques. This is a vast field of academic and industrial research, and new PE grades are being created and optimized to improve the processability of polyethylene in orientation processes, and to achieve the desired properties and stability after manufacturing. There is a need for a technology that overcomes as least some of the disadvantages that are known in this field.

### SUMMARY

In some implementations, there is provided a flexible packaging material comprising: a sealant web composed of polyethylene and comprising a sealing surface and an opposed lamination surface; a printing film comprising a hazy polymer layer composed of non-oriented high molecular weight (HMW) high density polyethylene (HDPE), the printing film having an inner surface and an outer surface; a printable material that is printed onto the inner surface of the printing film prior to lamination of the lamination surface of the sealant web to the inner surface of the printing film thereby sandwiching the printable material therebetween; and an adhesive disposed in between the sealant web and the printing film for lamination thereof.

In some implementations, the printing film is a monolayer of the non-oriented high molecular weight (HMW) high density polyethylene (HDPE). In some implementations, the printing film has a haze of at least 30%, at least 40%, at least 50%, at least 60%, at least 70% or at least 80%. In some implementations, the printing film has a haze of 50% to 95%. In some implementations, the printing film has a haze of 80% to 90%. In some implementations, the hazy polymer layer has a non-oriented HMW-HDPE content of at least 70 wt %, 75 wt %, 80 wt %, 85 wt % or 90 wt %, based on the total weight of the hazy polymer layer. In some implementations, the printing film has a stiffness between 100,000 and 160,000 psi for the machine direction (MD) secant modulus at 1% measured using ASTM D882.

In some implementations, the printing film is a coextruded multilayer film comprising: an external polymeric skin layer contiguous with the hazy polymer layer; and an internal polymeric skin layer contiguous with the hazy polymer layer, such that the hazy polymer layer is a core layer. In some implementations, the internal polymeric skin layer has high gloss properties, the printable material being applied to the internal polymeric skin layer. In some implementations, the external polymeric skin layer has high gloss properties, the printable material being applied to the internal polymeric skin layer. In some implementations, the internal polymeric skin layer has high haze properties, the printable material being applied to the internal polymeric skin layer. In some implementations, the external polymeric skin layer has high haze properties, the printable material being applied to the internal polymeric skin layer. In some implementations, high gloss properties are provided by medium density polyethylene (MDPE) as the polymeric material. In some implementations, high haze properties are provided by non-oriented HMW HDPE. In some implementations, the printing film has a stiffness of 80,000 to 100,000 psi and the sealant web has a stiffness of 50,000 to 80,000 psi, for the machine direction (MD) secant modulus at 1% measured using ASTM D882. In some implementations, the external polymeric skin layer or the external polymeric skin layer, or both, comprise a bimodal medium density polyethylene resin facilitating mat properties and reduce the melting point of the layer.

In some implementations, the printing film has a thickness between 0.5 and 1.3 mil. In some implementations, the printing film has a thickness between 1.7 and 2.5 mil or between 1.8 and 2.2 mil. In some implementations, the printing film has a thickness between 1 and 2 mil or between 1.2 and 1.6 mil. In some implementations, the printing film has a thickness up to 2.5 mil.

In some implementations, the sealant web comprises food-grade post-consumer recycled (PCR) material. In some implementations, the PCR comprises high-density polyethylene (HDPE). In some implementations, the PCR is present in the flexible packaging material in an amount between 20 wt % and 60 wt % based on the total weight of the flexible packaging material.

In some implementations, the printable material comprises ink that is water based or organic phase based. In some implementations, the printable material comprises a high oxygen (gas) barrier material. In some implementations, the high oxygen (gas) barrier material comprises a single-component barrier coating selected from SiegwerkCIRKIT® OxyBar BC 1582 and Henkel LOCTITE® Liofol BC 1582 RE. In some implementations, the gas barrier material is provided in a thickness corresponding to 0.5 to 1.5 lbs/ream.

In some implementations, the hazy polymer layer comprises a metallocene comprising linear low-density polyethylene (mLLDPE). In some implementations, the metallocene is present in the hazy polymer layer in an amount between 1 wt % and 15 wt %, or between 10 wt % and 45 wt %, based on the total weight of the hazy polymer layer. In some implementations, the hazy polymer layer comprises linear low-density polyethylene (LLDPE). In some implementations, the LLDPE is present in the hazy polymer layer in an amount between 10 wt % and 45 wt %, or between 10 wt % and 45 wt %, based on the total weight of the hazy polymer layer. In some implementations, the LLDPE and/or mLLDPE is present in a quantity sufficient to provide tackiness to the printing film for self-connection at a sealing temperature between 80° C. and 120° C. to form a packaging article.

In some implementations, the non-oriented HMW-HDPE is present in the hazy polymer layer in an amount of at least 50 wt %, optionally between 50 wt % and 65 wt %, based on the total weight of the hazy polymer layer. In some implementations, the non-oriented HMW-HDPE is present in the hazy polymer layer in an amount between 55 wt % and 98 wt % or between 55 wt % and 95 wt %, based on the total weight of the hazy polymer layer. In some implementations, the hazy polymer layer is non-lacquered.

In some implementations, the printing film is a co-extruded three-layer film with glossy skin layers and the hazy polymer layer is a core layer, and the hazy polymer layer, the glossy skin layers, and the printing film have one of the following thickness properties: the printing film has a layer ratio that includes the core layer being 50-70% and the glossy skin layers being 15-25%; and the printing film has a thickness between 1 and 2 mil. In some implementations, the printing film is a monolayer of the hazy polymer layer, and the hazy polymer layer has a thickness between 1.25 and 1.5, though this can also be the case for other situations including co-extrusion.

In some implementations, there is provided a use of non-oriented high molecular weight (HMW) high density polyethylene (HDPE) as a hazy polymer layer in printing film used in a flexible packaging material, optionally comprising one or more features as defined in any one of claims 1 to 36.

In some implementations, there is provided a flexible packaging material comprising a printing film comprising a hazy polymer layer composed of non-oriented high molecular weight (HMW) high density polyethylene (HDPE), the printing film having an inner surface and an outer surface and being configured to be reverse printed upon and to be laminated with a polyethylene-based sealant web, the hazy polymer layer having a thickness between 0.5 mil and 2.5 mil and a pre-lamination haze above 10%, optionally between 30% and 90% in monolayer or between 10% and 15% when co-extruded with glossy skin layers. It is noted that the material can further include one or more features as described above or herein.

In some implementations, there is provided a printing film for use in a flexible packaging material to provide a matte finish, comprising a hazy polymer layer composed of non-oriented high molecular weight (HMW) high density polyethylene (HDPE), the printing film having an inner surface and an outer surface and being configured to be printed upon and to be laminated with a polyethylene-based sealant web, the printing film having a thickness between 0.5 mil and 2.5 mil and a haze of at least 30%.

In some implementations, there is provided printing film for use in a flexible packaging material to provide a glossy finish, comprising a hazy polymer layer composed of non-oriented high molecular weight (HMW) high density polyethylene (HDPE), the hazy polymer layer being a core layer that is contiguous with skin layers composed of polyethylene having glossy properties, the printing film having an inner surface and an outer surface and being configured to be printed upon and to be laminated with a polyethylene-based sealant web.

In some implementations, there is provided a process of making a printing film for use in flexible packaging material, comprising: subjecting a hazy polymer material to a blown film process to produce a printing film, the hazy polymer material being based on non-oriented high molecular weight (HMW) high density polyethylene (HDPE); and controlling the blown film process such that the printing film is a monolayer of the non-oriented HMW-HDPE having a thickness between 1.25 and 1.5 and a haze of at least 30%.

In some implementations, there is provided a process of making a printing film for use in flexible packaging material, comprising: subjecting a hazy polymer material and a glossy polymer material to a blown film process to produce a printing film, the hazy polymer material being based on non-oriented high molecular weight (HMW) high density polyethylene (HDPE); and controlling the blown film process such that the printing film is a co-extruded three-layer film comprising glossy skin layers and a core layer of the hazy polymer material, and such that the core layer has a thickness between 0.5 and 1 mil and the printing film has a haze below 12%, and optionally above 10%.

It is also noted that the process can include one or more additional features for producing the printing film and/or packaging material as defined above or herein.

### BRIEF DESCRIPTION OF THE DRAWINGS FIGURES

FIG. 1 is a side cut view schematic of an example packing material.

FIG. 2 is a side cut view schematic of an example printing film.

FIG. 3 is a side cut view schematic of an example printing film.

FIG. 4 is a side cut view schematic of an example printing film.

### DETAILED DESCRIPTION

The present description relates to flexible packaging material that includes a sealant web and a printing film that has a hazy polymer layer composed of non-oriented (NO) high molecular weight (HMW) high density polyethylene (HDPE) as the main component in the layer formulation. The NO-HMW-HDPE hazy polymer layer can facilitate various desired properties for flexible packaging materials.

When the NO-HMW-HDPE hazy polymer layer defines an external surface of the flexible packaging material, it defines a matte finish to the packaging while still enabling the print to be well visible. The print can be applied directly to the hazy polymer layer on its inner surface and still provides adequate printing quality as evaluated on the film's outer surface. While industry standards and practices point toward the use of low haze polymers to provide desired printability and visibility for the finished product, it was surprisingly found that formulations with NO-HMW-HDPE hazy polymer, which has relatively high haze reaching into the 80 percents, can be used to provide adequate printability as well as an excellent matte finish when defining the external surface. When the printing film further includes an outer polymer layer having a glossy finish which is contiguous with the NO-HMW-HDPE hazy polymer layer, the flexible packaging can be given a glossy finish while the hazy polymer layer does not negatively impact visual aspects of the finished packaging. By using a NO-HMW-HDPE hazy polymer layer, notable processing savings using widely available resins can be achieved while providing flexible packaging material that has desirable properties for various packaging applications, such as stand-up pouches (SUPs), as well as recyclability when used with PE-based sealant webs.

HMW HDPE resins have been used in flexible packaging, but not in the same applications as in the present description. The applications described in the resins' technical data sheets are mainly T-shirt bags, produce bags, trash bags, merchandise bags and as multi-wall liners in paper bags. These products are generally unprinted, or simply surface-printed, but are not used for high-definition reverse printing as in the applications covered by the present description. Indeed, industry practice and principles have pointed away from the use of hazy polymer materials for the applications described herein. An example is shown in the Fifth Annual Special Supplement to 2024 Q1 Issue, Converting Quarterly, where at page 36 it is noted the “PE films made from blown or cast processes may lack certain properties that are required in packaging conversion and the optics of HDPE-rich films are lower compared to PET/PE structures, making them undesirable in premium packaging that contains see-through windows.” However, the work described herein found that hazy polymer layers can yield surprisingly good results.

The sealant web and the printing film can be tailored in terms of various properties to provide final flexible packaging for different applications. For example, the thickness, stiffness, melting gap between the two, layer structure, and other properties can be selected to provide the finish (e.g., matte or gloss), the structural features (e.g., stand-up applications, packaging size and weight contained in the packaging) and/or other features for certain applications.

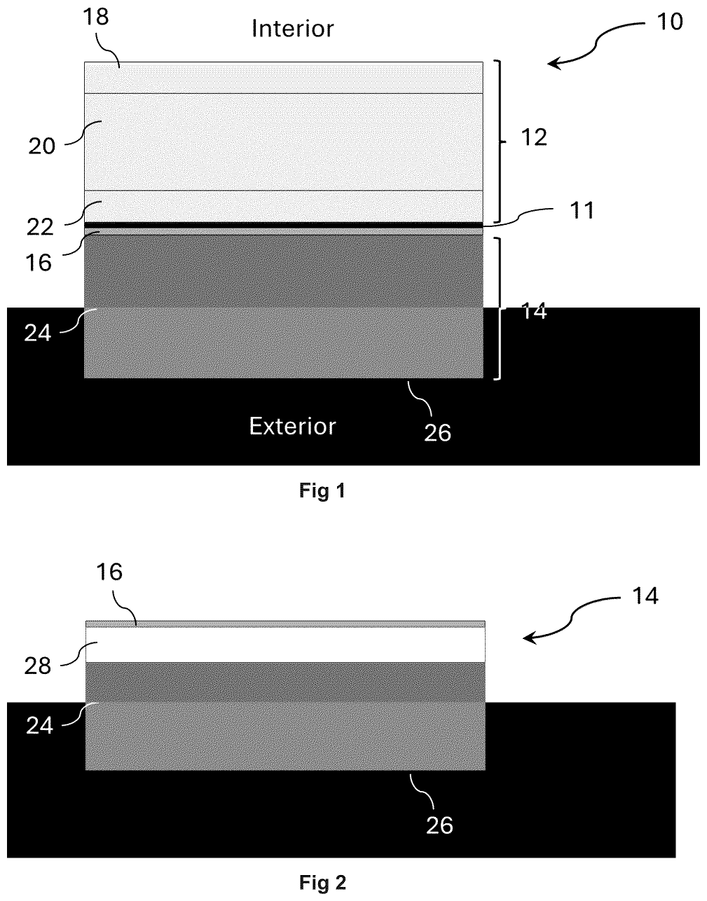

Referring to FIG. 1, the flexible packaging material 10 can include a sealant web 12 and a printing film 14 on which a printing material 16 is applied. A lamination adhesive 11 is applied to join the two films. The sealant web 12 can include various layers, including a skin layer for sealing 18, and an intermediate layer 20 and a skin layer for lamination 22, all of which are PE-based while having different chemical and physical characteristics depending on the needs of the packaging product. The printing film 14 includes a hazy polymer layer 24 composed principally of NO-HMW-HDPE, as shown in FIG. 1, but it can also include additional layers depending on properties that may be desired. Certain embodiments and implementations will be described in greater detail below.

### Matte Finish Flexible Packaging Materials

As shown in FIGS. 1 and 2, the flexible packaging material includes an exterior surface defined by the hazy polymer layer 24 of the printing film 14. The exterior surface is thus composed principally of NO-HMW-HDPE which can facilitate a matte finish.

In some implementations, as shown in FIG. 1, the printing film 14 can be a monolayer of NO-HMW-HDPE that is printed on directly on its inner surface and, after lamination with the sealant web 12, the outer surface 26 of the printing film 14 provides an excellent matte finish. In this example configuration, the inner surface of the monolayer hazy polymer layer receives the printing material 16 directly. The monolayer example has been found to provide an excellent matte finish as well as excellent print visualization on the film's outer surface, which is contrary to practices and principles in the field. The monolayer can have a thickness between 0.3 and 2.5 mil, preferentially between 0.9 and 1.6 mil, or other thickness ranges. The NO-HMW-HDPE can be the only PE material in the monolayer or can be present in at least 50 wt %, at least 60 wt %, at least 70 wt %, at least 80 wt %, at least 90 wt %, or at least 95 wt % with the remainder being other PE resins such as linear low density polyethylene (LLDPE).

In alternative implementations, the inner surface of the NO-HMW-HDPE hazy polymer layer 24 can have a glossy PE skin layer 28 such that the printing is performed on the glossy PE skin layer 28 while the outer surface of the printing film is still defined by the NO-HMW-HDPE material, thus providing a matte finish. In this scenario, the NO-HMW-HDPE would be present as a core layer and outer skin layer. The glossy PE layer 28 can provide a smoother surface for printing, if desired for certain applications, while still benefiting from the matte finish features of the hazy polymer layer. The glossy PE skin layer 28 can have a thickness corresponding to 10% to 25% of the printing film 14 thickness while the NO-HMW-HDPE hazy polymer layer 24 (including the core and the outer skin) can have a thickness of 75% to 90% of the printing film 14 thickness for this embodiment.

### Glossy Finish Flexible Packaging Materials

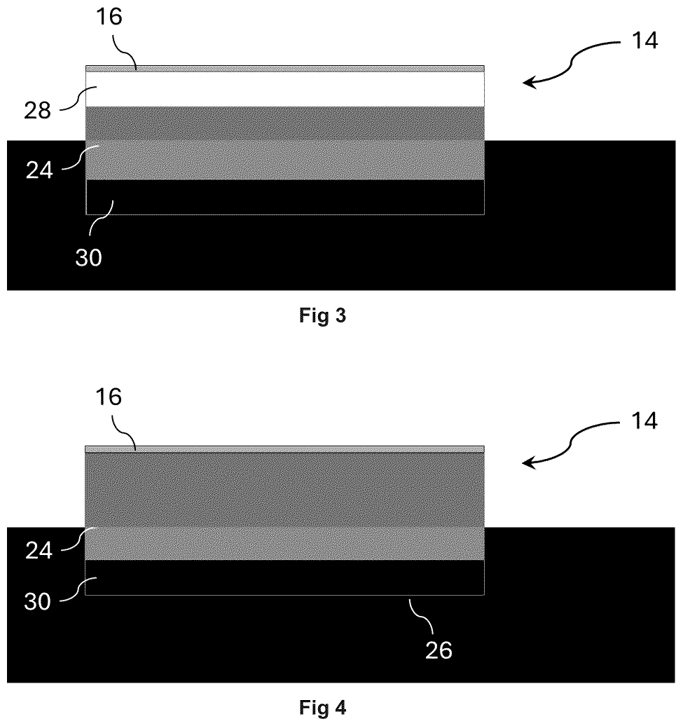

As shown in FIGS. 3 and 4, the printing film 14 can have an outer glossy PE skin layer 30 applied to the hazy polymer layer 24 to provide a glossy finish to the packaging product. The surface on which the printing occurs can either be the hazy polymer layer 24 (as in FIG. 4) or an inner glossy PE layer 28 (as in FIG. 3). In the embodiment of FIG. 3, the inner glossy PE skin layer 28 can have a thickness of 10% to 25% of the printing film 14 thickness while the NO-HMW-HDPE hazy polymer layer 24 can have a thickness of 50% to 80% of the printing film 14 thickness and the outer glossy PE skin layer has a thickness of 10% to 25% of the printing film 14. In the embodiment of FIG. 4, the NO-HMW-HDPE hazy polymer layer 24 can have a thickness of 75% to 90% of the printing film 14 thickness while the outer glossy PE skin layer 30 has a thickness of 10% to 25% of the printing film 14.

Regarding the glossy PE layers, medium density polyethylenes (MDPEs) used as the main components of the skin layer are excellent candidates for gloss and clarity, with some grades offering higher stiffness. It is noted that MDPE can be the principal PE component in such layers with other PE resins being optionally present depending on desired properties or processing conditions.

### Definitions and Comments on Context and Development

It is noted that the term “non-oriented” in reference to the non-oriented high molecular weight (HMW) high density polyethylene (HDPE) of the printing film means that the polymer material has not been subjected to orientation processing other than that occurring during the film blowing process, for example using machine-direction orientation process (MDO) or a tenter-frame process. The NO-HMW-HDPE is thus not oriented in a machine direction or biaxially or otherwise. It is nevertheless noted that some degree of orientation can arise from polymer manufacturing and the blown film process, but no dedicated orientation process is performed.

The term “hazy polymer layer” which is based on a non-oriented high molecular weight (HMW) high density polyethylene (HDPE) resin refers to a polymer layer having surface properties that result in a high haze level. When a matte finish is desired, the hazy polymer layer can define the outer surface of the flexible packaging material. When a glossy finish is desired, the hazy polymer layer can be an intermediate layer to which an outer glossy polyethylene layer is applied. The haze level of the hazy polymer layer can be determined prior to printing and lamination. In this regard, the haze level of the hazy polymer layer may not be measurable in the case of a coextruded film where the outer skin layers are glossy.

The term “printable material” includes materials that can be printed using flexography and/or digital printing and/or any other printing process commonly used in the flexible packaging industry onto the printing film. The printable materials include inks for reverse printing which may be water based or organic phase based. The printable materials can also include high oxygen (gas) barrier materials that can be print coated onto the printing film for certain applications.

By way of additional background and context for the present technology, the following comments are also provided. It is noted that certain features described below can be used in conjunction with the products and methods described herein. A large proportion of flexible plastic packaging consists of a minimum of two films: one of the films is used as the sealing film (also referred to as the sealant web), while the other is the printing film, which is printed in reverse and laminated to the sealant web after printing. The printing film is preferably printed on the reverse side, so that the ink is sandwiched in the structure and the print is not altered during the useful life of the packaging. In industry, the sealant web is preferably a polyethylene film manufactured by the blown film process, the attributes of which include good sealing performance, general mechanical properties required for packaging, and surface properties enabling the film to be converted by lamination. The thickness of the sealing film can generally range from 1 to 6 mils. The printing film is usually a very thin film (0.4 to 1 mil) with very good optical properties (low haze and high gloss), thermal resistance far superior to polyethylene (PE) (for example, by comparing melting temperatures), and a stiffness often characterized by a very high tensile modulus (e.g., by measuring the tensile secant modulus) compared to the sealant web, for the present self-standing packaging applications. To name but a few, oriented or non-oriented polypropylene (PP), polyethylene terephthalate (PET) and polyamide (PA) films are used as reverse printing films.

Lamination is the process step where the two films—the sealing film and the printing film—can be joined together using a liquid or molten adhesive, for example. In laminated structures, it is conventionally the printing film that provides some of the packaging's stiffness, especially for stand-up pouches (SUPs), such as classic SUPs, side or bottom gusseted pouches, pinch bottom pouches, pillow pouches, and sideweld pouches. After lamination, the two laminated films are converted into packaging, e.g., pouches, or the roll of laminated film is sent to a packer company, which shapes the packaging as it is filled. Most of these pouches offer the advantage of being re-closable or resealable. In all cases, the gap in thermal properties between the sealant web and the printing film enables easy conversion to packaging for any type of converting equipment, since for conventional systems only the PE sealant web or a layer of PE sealant web will melt during sealing, without altering the outer printing layer that is not made of PE. The PE used for sealing has a typical sealing initial temperature (SIT) of between 80° C. and 120° C., while PP melts at around 160°-170° C. and PET at around 250° C. Thus, in such cases, there is a notable gap in softening temperatures between the printing film and the sealing layer, between 40° C. and 130° C. Such structures are found in many packaging applications, including food and beverage packaging, personal care and cosmetics packaging, pharmaceutical and nutraceutical packaging, household products packaging, and industrial and chemical product packaging. It has generally been believed that this temperature gap combined with the high level of stiffness is necessary to avoid any deformation or distortion of the packaging during manufacturing.

One disadvantage of such multi-polymer structures is that the packaging cannot easily be recycled after use, due to its structure of immiscible resins. Given that the majority of packaging contains polyethylene, and that polyethylenes are the most widely used resins in flexible packaging, developing a monomaterial package structure can be an advantageous way of bringing flexible packaging into the circular economy. One way of achieving a monomaterial package is to use only a surface-printed polyethylene film. As it is not possible to use a single film in the majority of applications that use laminated films, the most common way has been to use an oriented polyethylene film as the printing film. To achieve the highest moduli, high-density polyethylene (HDPE) is the predominant material that has been used. New HDPE grades have been launched to improve the use of HDPE in orientation processes. The processes used to orientate films are machine direction orientation (MDO, to orientate the film in the machine direction) and biorientation (BO) processes. A whole range of MDO equipment is available, either in line with the blown film extrusion process or separate from it, to produce MDO PE. Biaxially oriented polyethylene (BO-PE) is obtained by biorientation on a cast extrusion line, and a number of processes have been under development to obtain BO-PE with the same stable properties as BO-PET. It is believed that orienting PE also increases the temperature resistance of the PE, thereby widening the temperature gap between the printing film and the web sealant layer. MDO PE films have mainly been used to manufacture monomaterial laminated flexible packaging, generally with a thickness of 0.9-1.1 mil; these films are glossy, because the orientation process involves stretching the films and smoothing out any surface defects naturally present on blown films. To obtain a matte finish, the MDO PE film would have to be modified by adding a coating of lacquer only on the outer side of it. The other side remains glossy as it is considered the optimum surface for printing by industry. Concerning the adhesive used between the two laminated PE films, it has been shown that certain adhesive compositions used under controlled conditions enable the recyclability of flexible packaging to be recognized according to protocols developed by certification bodies, such as the Association of Plastic Recyclers (APR) and the standardized How2Recycle labeling system in North America and RecyClass and CEFLEX in Europe.

In terms of the present work, development of thin polyethylene printing films without the use of an orientation process was explored. Several types of HDPE were used in trials, with the aim of obtaining dimensional and processability characteristics. There were numerous iterations on monolayer machines with different die types, high stalk and conventional, as well as on coextruded multilayer machines, using grooved feed and smooth bore extrusion barrels, and different conditions of cooling the extruded bubble. The high stalk process was shown to be favorable for increasing the matte appearance of HDPE films, but conventional stalk was also used to develop these films to achieve a better thickness profile. The grooved-feed extruder reduced the effect of high head pressure, resulting in higher, more stable output. One challenge was to obtain a thin, stiff film without wrinkles during winding process. Various adjustments were made to the process during trials to achieve desired results. For the matte film, the aim was to achieve the lowest possible gloss, e.g., below 11 GU. In experiments, the work obtained matte films and glossy films of 1 to 1.5 mil that were considered stiff, but with very low moduli compared with MDO PEs. In addition, haze was present in the films. In ASTM D1003, haze in plastics can be defined as the percentage of incident light scattered by more than 2.5° through the plastic specimen. Haze can be seen as measuring the milkiness of the film and is typically expressed in percentage (%). Haze is an important optical property to measure where transparency is necessary. In the case of matte films, films made predominantly of high molecular weight high density polyethylene, HMW-HDPE, were obtained with the desired mechanical properties and exceptional matte appearance. However, haze levels were very high compared with known films and oriented polyethylene films. It was thought that reverse printing would not be perfectly visible with the developed hazy films and would not meet the requirements for this type of packaging. On the manufactured pouches—after printing, lamination and conversion to packaging—the gloss measured for matte packaging was between 4 and 7.5 GU. For the glossy film, a co-extruded 3-layer structure was designed with the aim of reducing the amount of HMW-HDPE in the film, to reduce the haze caused by the irregular surface of HMW-HDPE films. It was found that a high concentration of a medium-density polyethylene (MDPE) was shown to increase the gloss of the film, even though the core layer of the film was made of the same HMW-HDPE as the matte film. The skin layers may only have MDPE as the PE resin and/or have no HMW-HDPE. The glossy multilayer films obtained had higher haze levels and lower gloss compared to known films (e.g., oriented PE and other polymer films). The MD secant modulus of MDO PE films was measured at 240,000 to 270,000 psi, while the moduli of the printing films developed in the present work were around 70,000-150,000 psi.

In order to improve the stiffness desired for packaging, such as SUPs, the work developed sealant webs with improved stiffness properties, with the aim of increasing the overall stiffness of the laminate structure, while retaining optimum sealing properties. However, the maximum gap between the seal initiation temperature (SIT) of the sealant layer and the melting temperature of the print layer was around 30-40° C., suggesting potential difficulties in converting the laminated films. As the present work's printing films were thicker than the known films, development was conducted to reduce the thickness of the sealant webs so that the thickness of the complete structure remained constant. For example, the present work aimed to replace a 2 mil PE film structure laminated to a 0.80 mil oriented PP film (PE-sealant 2 mil//OPP 0.8 mil) by a stiffer 1.5 mil PE film with a 1.25 mil PE-print film (PE-sealant 1.5 mil//PE-print 1.25 mil) in order to retain the packaging properties for the intended application. Similarly, the present work replaced a PE-sealant 3.5 mil//PET 0.48 mil with a PE-sealant 2.5//PE-print 1.5 mil). These are some examples of the packaging materials that were developed.

Furthermore, the present work tested the incorporation of food-grade post-consumer recycled (PCR) material in some of the sealant webs for monomaterial applications. To our knowledge, the only commercially available grade since March 2023 is NOVA Chemicals® Syndigo™ rPE-0860-FC. It is sourced from high-density polyethylene (HDPE) milk, water, and juice jugs, according to the material's data sheet, and can be used in rigid and flexible packaging. The present work used various ratios of PCR resin, for example increasing the amount of PCR resin so that the complete packaging structure (sealant web and printing film) contained 30% PCR resin. PCR incorporation was indeed possible while maintaining desired packaging properties. A so-called window, which is an unprinted part of the packaging, showed a haze of 24% for pouches containing 30% PCR resin and featuring the gloss finish, enabling the contents of the bag to be seen very clearly.

The developed sealant webs as well as the glossy and matte printing films were then subjected to conversion, for production of laminated structures. Flexography and digital printing were both tested, despite that digital printing for example was not recommended except for MDO PE films due to the improved surface quality and the lower thickness of MDO PE films. Surprisingly, it was possible to print the printing films well with the digital process. Flexographic printing was also possible. Next, the printed films were laminated with sealant webs, and then converted into pouches on traditional pouch machines. With some adjustments to account for the outer layer of the structure having a lower temperature resistance compared to known films, the conversion was carried out at a speed very similar to that of conventional pouch structures, and there were no problems in inserting the all-polyethylene zip during the process. Good conversion of the novel film structures was therefore completed.

In addition, it was surprisingly found that the print rendering on the packaging was exceptional, despite the poor clarity (high haze) of the matte and gloss printing films. In particular, the appearance of the matte film was notably impressive. MDO PE films are all relatively glossy due to the orientation process, which stretches the film. To obtain a matte finish to such oriented films, it is then necessary to add a lacquer to the film to give it this matte appearance. The matte printing film of the present work, therefore, also avoids an additional conversion step to make MDO printing films matte, i.e., they can avoid a lacquering step.

Despite the lower stiffness of the present work's printing films compared with MDO films, the resulting stand-up pouches were found to have properties similar to conventional pouches. Quality testing for pouches inflated and pressurized in a water basin as described in ASTM D3078 and F2096 showed the integrity of this type of pouch. Stand-up pouches obtained with PCR resin-filled sealant web gave similar results, while demonstrating easy-tear properties for opening sealed pouches. Various processes can be used to convert film into packaging. Some processes can prepare the final packaging upstream, using pouch making machines for example, and these are then sent to packers for filling. Other processes use film received directly in rollstock form and convert the film into packaging and fill it in a single step, using vertical form film seal (VFFS) packaging machines or horizontal form fill seal (HFFS) machines. For the pinch-bottom pouch application, the ends of the pouch are sealed by additionally sealing the outer packaging surface to itself. This provides a kind of “tack” that allows the pouch to stand upright on store shelves. An example of a traditional structure is a PE sealant web with an oriented polypropylene (OPP) printing film. Due to its nature, the OPP film develops tackiness from 90-100° C., but does not melt completely. To achieve this tackiness, the present work modified the matte film made mainly of HMW-HDPE to make it stickier. Surprisingly, it was possible to modify it by incorporating a specific metallocene linear low-density polyethylene (mLLDPE) with a density of 0.913 g/cm³ at 20 wt % to 40 wt % without losing much of the matte appearance: instead of 4-6 gloss units (GU) measured with a BYK Microgloss 45°, it was possible by modifying the film recipe and operating conditions to obtain a film with a gloss between 8-11 GU, with a reduced modulus. It was possible to print this film much less stiff than all the other printing films used in these types of application. Modifications were also made to the sealant web: to increase sealing speed in this application, the composition of the sealant web was modified to lower the seal initiation temperature (SIT) by 10° C. to 105° C. and minimize the drop in stiffness (measured secant modulus).

The structures described in this section are suitable for a range of food and other products but are unsuitable where high oxygen and gas barriers are required. However, the packaging materials describe herein can be adapted for such gas barrier applications. It is generally necessary to use layers of barrier resins in the film structure or as a coating. Typical resins used are ethylene vinyl alcohol copolymer (EVOH) or EVOH combined with polyamides (PA), or polyvinylidene dichloride (PVDC). The addition of these resins, in the form of films, film layers or coatings, is an obstacle to the recycling of barrier films. Several technologies have been developed to enable barrier films to be recycled. One of the most widely used technologies is to add compatibilizers to EVOH barrier films containing 7+ layers, such as those developed by Dow, Ampacet and Ingenia, which have received letters of recognition from the Association of Plastic Recyclers (APR). In this technology, the EVOH layer is compatibilized in the form of fine droplets (around 1 micron in diameter) in a polyethylene matrix during recycling. Other technologies involve adding very thin layers of a barrier coating to the films. Henkel, for example, has developed coatings that have resulted in flexible packaging with high barrier properties. A popular belief is that the coating must be deposited on oriented films. On MDO PE films, it has been shown to be possible to deposit thin layers of coating, and the packaging has been shown to be recyclable as a polyethylene monomaterial package (notably by RecyClass in Europe). It was believed that the highly irregular surface of non-MDO films would not allow continuous coating deposition, due to the “mountains” and “valleys” present on the surface of these films. These asperities, bumps and cavities, are greatly smoothed out by the MDO process. Moreover, it has been thought that if it were possible to obtain a continuous coating layer on such films, this would require a very large quantity of coating compared with the quantity on MDO films. In addition, by the very nature of HDPE, surface defects are much more apparent on HDPE films, giving rise to the very high haze and matte appearance of the film. Such factures seemed to militate against the use of this type of coating on non-oriented films. However, such coatings could be applied to the HMW-HDPE hazy polymer layer as described herein to produce packaging material with gas barrier properties. Even if more of the gas barrier coating is applied compared to MDO applications, the savings achieved by using the film blowing process alone, without any subsequent orientation process, could certainly compensate. Alternatively, the coating could be applied to the sealant web before lamination, as the surface of the outer skin was predominantly made of linear low-density polyethylene (LLDPE), with fewer surface defects. Tests were carried out on both sealant webs and printing films. Unexpectedly, it was possible to achieve excellent properties with all the films, and work was continued on the printing films. It was demonstrated that high-barrier films could be obtained on these films without the need for further coating, with excellent results. The conditions for adding the coating are very similar to those used for MDO PE films. One advantage of this type of recyclable barrier structure is that a high concentration of food-grade HDPE PCR resin can be added to the web sealant, as described above.

### EXAMPLES & EXPERIMENTATION

The following section provides additional information regarding experiments and tests that were conducted as well as results.

### Example 1

Printing film—matte finish: A preferred matte printing film composition is shown in below Table 1. Depending on the extrusion line used, it can be helpful to add additives to the formulation. An example of an alternative composition is shown in Table 2. The additives in the formulations are among the preferred additives listed by APR as workhorse additives historically used without issue for recycling.

TABLE 1

| | Layer | | | |
|---|---|---|---|---|
| Layer # | ratio % | Composition | | % |
| 1 | 100 | ExxonMobil ™ | HDPE HD 7960.13 | 90 |
| | | NOVA Chemicals ® | Surpass ® SPs116 | 10 |

TABLE 2

| | Layer | | | |
|---|---|---|---|---|
| Layer # | ratio % | Composition | | % |
| 1 | 100 | ExxonMobil ™ | HDPE HD 7960.13 | 88 |
| | | NOVA Chemicals ® | Surpass ® SPs116 | 10 |
| | | — | Additives | 2 |

The example film was produced in a monolayer blown film extrusion line. HD 7960 is an example of NO HMW HDPE resin that can be used in this film. The film properties described in Table 3 were measured for several film thicknesses. Film #3 uses Marlex® TRB-115 instead of HD 7960, which is another grade of HMW HDPE produced by Chevron Phillips Chemical. This work observed lower values for secant moduli, but overall film #3 remained very stiff. The average gauge is measured with an Octagon Blown Film Control. Tensile properties, such as Secant Modulus, Tensile Stress at Yield, Tensile Stress at Break, Elongation at Break are measured in accordance with ASTM D882.

TABLE 3

| | | MD | TD | | |
|---|---|---|---|---|---|
| | | Secant | Secant | | |
| | Average | Modulus | Modulus | | Gloss |
| Film | Gauge | (1%) | (1%) | Haze | (45 Deg.) |
| # | (mil) | (PSI) | (PSI) | (%) | (GU) |
| 1 | 1.25 | 124,000 | 162,000 | 83.9 | 5.7 |
| 2 | 1.35 | 148,000 | 189,000 | 85.3 | 5.4 |
| 3 | 1.59 | 111,000 | 139,000 | 84.3 | 4.5 |
| 4 | 1.63 | 124,000 | 164,000 | 88.3 | 4.5 |

The printing films were reverse printed using flexography and digital printing. The films exhibited excellent prints with an impressive matte finish. The printing films were then laminated to sealant webs (SW) whose properties are described in Table 4.

All films were converted to SUP using a pouch making machine. In most applications, it was shown to be preferable to use sealant webs with a higher stiffness, higher than 50,000 psi, and preferably higher than 60,000 psi for MD secant tensile modulus, than the polyethylene sealant webs traditionally used in lamination with non-PE printing films, with MD secant tensile moduli as low as 25,000 psi can be found.

TABLE 4

| | | MD Tensile | TD Tensile | MD Tensile | TD Tensile | MD | TD | MD Secant | TD Secant |
|---|---|---|---|---|---|---|---|---|---|
| | Average | Stress at | Stress at | Stress at | Stress at | Elongation | Elongation | Modulus | Modulus |
| Film | Gauge | Break | Break | Yield | Yield | at Break | at Break | (1%) | (1%) |
| # | (mil) | (PSI) | (PSI) | (PSI) | (PSI) | (%) | (%) | (PSI) | (PSI) |
| SW1 | 1.5 | 6,200 | 4,500 | 2,300 | 2,200 | 610 | 840 | 70,000 | 85,000 |
| SW1 | 2 | 5,400 | 4,600 | 2,200 | 2,300 | 680 | 870 | 57,000 | 72,000 |
| SW2 | 1.6 | 5,600 | 3,800 | 2,200 | 2,200 | 600 | 800 | 61,000 | 83,000 |
| SW2 | 2.3 | 5,000 | 4,600 | 2,200 | 2,300 | 730 | 900 | 58,000 | 74,000 |
| SW3 | 3.5 | 5,000 | 4,900 | 2,600 | 2,800 | 870 | 900 | 78,000 | 92,000 |

### Example 2

In order to achieve the tacky effect for sealing the outer surface of the printing film to itself, the film in Example 1 was modified and one of the preferred compositions is shown in table 5.

TABLE 5

| | Layer | | | |
|---|---|---|---|---|
| Layer # | ratio % | Composition | | % |
| 1 | 100 | ExxonMobil ™ | HDPE HD 7960.13 | 59 |
| | | NOVA Chemicals ® | Surpass ® VPsK914 | 39 |
| | | — | Additives | 2 |

Depending on the extrusion line used, it is sometimes preferred to modify the formulation. An example of an alternative composition is shown in Table 6 for use in a three-layer coextrusion blown film line.

TABLE 6

| | Layer | | | |
|---|---|---|---|---|
| Layer # | ratio % | Composition | | % |
| 1 | 20 | ExxonMobil ™ | HDPE HD 7960.13 | 57 |
| | | NOVA Chemicals ® | Surpass ® VPsK914 | 40 |
| | | — | Additives | 3 |
| 2 | 60 | ExxonMobil ™ | HDPE HD 7960.13 | 58 |
| | | NOVA Chemicals ® | Surpass ® VPsK914 | 40 |
| | | — | Additives | 2 |
| 3 | 20 | ExxonMobil ™ | HDPE HD 7960.13 | 57 |
| | | NOVA Chemicals ® | Surpass ® VPsK914 | 40 |
| | | — | Additives | 3 |

Table 7 shows the properties obtained for this composition. Several blown film extrusion machines were used to obtain the most successful and preferred film in terms of absence of wrinkles during film winding.

TABLE 7

| | | MD Secant | TD Secant | | |
|---|---|---|---|---|---|
| | Average | Modulus | Modulus | | Gloss |
| | Gauge | (1%) | (1%) | Haze | (45 Deg.) |
| Line # | (mil) | (PSI) | (PSI) | (%) | (GU) |
| 1, Mono | 1.27 | 73,000 | 105,000 | 56.4 | 9.3 |
| 2, Mono | 1.32 | 80,000 | 108,000 | 56.1 | 9.3 |
| 3, Coex | 1.20 | 91,000 | 133,000 | 52.0 | 11.6 |

To achieve a glossy outer surface, the outer layer of the printing film could be modified in a coextruded structure. Table 8 shows the composition of the potential film. Layer #1 is the outer skin layer of the printing film.

TABLE 8

| | Layer | | | |
|---|---|---|---|---|
| Layer # | ratio % | Composition | | % |
| 1 | 20 | Chevron Phillips Chemical | Marlex ® D350 | 84 |
| | | DOW ™ | LDPE 611A | 11 |
| | | — | Additives | 5 |
| 2 | 60 | ExxonMobil ™ | HDPE HD 7960.13 | 79 |
| | | NOVA Chemicals ® | Surpass ® SPs116 | 20 |
| | | — | Additives | 1 |
| 3 | 20 | ExxonMobil ™ | HDPE HD 7960.13 | 79 |
| | | NOVA Chemicals ® | Surpass ® SPs116 | 20 |
| | | — | Additives | 1 |

Table 9 shows an alternative composition to that shown in Table 8.

TABLE 9

| | Layer | | | |
|---|---|---|---|---|
| Layer # | ratio % | Composition | | % |
| 1 | 20 | Chevron Phillips Chemical | Marlex ® D350 | 84 |
| | | DOW ™ | LDPE 611A | 11 |
| | | — | Additives | 5 |
| 2 | 60 | ExxonMobil ™ | HDPE HD 7960.13 | 79 |
| | | NOVA Chemicals ® | Surpass ® SPs116 | 20 |
| | | — | Additives | 1 |
| 3 | 20 | Chevron Phillips Chemical | Marlex ® D350 | 84 |
| | | DOW ™ | LDPE 611A | 11 |
| | | — | Additives | 5 |

The film with a specific thickness of 1.25 mil was produced on two three-layer coextrusion lines and was reproduced several times. Film properties are shown in Table 10.

TABLE 10

| | | MD | TD | | |
|---|---|---|---|---|---|
| | | Secant | Secant | | |
| | Film | Modulus | Modulus | | Gloss |
| Film #, | Thickness | (1%) | (1%) | Haze | (45 Deg.) |
| Line # | (mil) | (PSI) | (PSI) | (%) | (GU) |
| 1, 1 | 1.25 | 93,000 | 127,000 | 11.6 | 57.9 |
| 2, 2 | 1.25 | 97,000 | 130,000 | 11.6 | 60.7 |
| 3, 1 | 1.25 | 92,000 | 124,000 | 11.5 | 62.3 |
| 4, 1 | 1.25 | 93,000 | 126,000 | 12.4 | 58.7 |

From the formulation in Table 8, it is possible to return to a fully matte film by retaining the very stiff inner layer (layer 2) and reshaping the skin layers (layers 1 and 3). In the example in Table 11, the HDPE of the skin layers in Table 6 has been replaced by a bimodal medium-density polyethylene resin, enabling specific surface properties to be achieved. This formulation is shown in Table 11.

TABLE 11

| | Layer | | | |
|---|---|---|---|---|
| Layer # | ratio % | Composition | | % |
| 1 | 20 | Baystar ® | FB1350 | 46 |
| | | NOVA Chemicals ® | Surpass ® VPsK914 | 50 |
| | | — | Additives | 4 |
| 2 | 65 | ExxonMobil ™ | HDPE HD 7960.13 | 79 |
| | | NOVA Chemicals ® | Surpass ® SPs116 | 20 |
| | | — | Additives | 1 |
| 3 | 15 | Baystar ® | FB1350 | 55 |
| | | NOVA Chemicals ® | Surpass ® VPsK914 | 40 |
| | | — | Additives | 5 |

The resin ratios of the skin layers are modified according to the specific properties required, while maintaining the matt appearance of the desired film. Similarly, the ratio of resins in the inner layer can be modified according to the mechanical properties of the HDPE used. For example, replacing HD 7960.13 with the less stiff HD 7506.08 can benefit from increasing its composition from 79% to 89% in the layer to maintain the desired stiffness.

Another way of modifying the film's mechanical and physical properties is shown in this example, by modifying the layer ratios. Increasing the inner layer from 60% to 65% and decreasing layer 3 from 20% to 15% also increases the film's overall stiffness, while retaining the unchanged matt appearance. Film properties are shown in Table 12.

TABLE 12

| | | MD Secant | TD Secant | | |
|---|---|---|---|---|---|
| | Average | Modulus | Modulus | | Gloss |
| | Gauge | (1%) | (1%) | Haze | (45 Deg.) |
| Line # | (mil) | (PSI) | (PSI) | (%) | (GU) |
| 1, Coex | 1.25 | 79,000 | 112,000 | 56.4 | 14.5 |

The following provides a summary of optional thickness ranges for certain embodiments: A three-layer printing film could have a layer ratio of 20% for each outer skin and 60% for the core hazy layer, although other ratios are possible such as the core layer being 50-70% and the glossy skin layers being 15-25%, and the printing film can have a thickness between 1 and 2 mil, for example. It is preferred that the two outer skins are of the same thickness, but it is possible for them to be different. It is also possible to have more than three layers (e.g., 5, 7, 9) where the layer ratio is such that the outer skin layers are approximately 10% each and the multi-layer core would be approximately 80%, and the overall printing film can again have a thickness between 1 and 2 mil, for example (although the outer skin layers could also be 15% each and the multilayer core would then be 70%).

The following resin information is also provided in the context of the present description and technologies: Nova Chemicals® Surpass® VPsK914: can be replaced by Chevron Phillips Chemical Marlex® D163, Chevron Phillips Chemical Marlex® D143, Nova Chemicals® Surpass® SPs116, DOW™ Elite 5500G, ExxonMobil™ Exact™ 3236, Baystar® FB2230, ExxonMobil™ Exceed™ 1415, ExxonMobil™ Exceed™ 1012. Nova Chemicals® Surpass® SPs116: can be replaced by Nova Chemicals® SCLAIR® FP120; ExxonMobil™ Exceed™ 1015, DOW™ Elite 5400G, ExxonMobil™ Exceed™ 1018, ExxonMobil™ Exceed™ XP 6056 ML, ExxonMobil™ LLDPE LL 3001.63, SABIC® SUPEER 8115, SABIC® SUPEER 8118, Westlake Polyethylene™ HIFOR XTREME® SC74875, Westlake Polyethylene™ HIFOR XTREMER SC74858, Chevron Phillips Chemical Marlex® D143, Chevron Phillips Chemical Marlex® D139, ExxonMobil™ Exact™ 3236, Baystar® FB2230, ExxonMobil™ Exceed™ 1415, ExxonMobil™ Exceed™ 1012. ExxonMobil™ HDPE HD 7960.13: can be replaced by Chevron Phillips Chemical Marlex® TRB-115, ExxonMobil™ HDPE HD 7506.08, LyondellBasell Alathon L5005, LyondellBasell Alathon L5906, Sasol HD5208 FLX, Formosa Plastics® Formolene® E922, Formosa Plastics® Formolene® E924, Formosa Plastics® Formolene® E927, Baystar® FB1510, Baystar® FB1350, Baystar® HDPE 1285, Baystar® HDPE 2285, Baystar® 2287, Baystar® 2297. Note that in the manufacturers' Technical Datasheet, the applications and usages of these HMW HDPE resins is not specified or suggested; HMW HDPE are recommended for low-end applications such as grocery store produce bags and garbage bags. In addition, Chevron Phillips Chemical Marlex® D350: can be replaced by Baystar® Lumicene® mPE M2710 EP, Baystar® Lumicene® mPE M3410 EP, Baystar® Lumicene® M6410EP, NOVA Chemicals® NOVAPOL® TF-Y534-IP.

It is also noted that various features described herein can be combined with other features and embodiments and implementations. Various LDPEs can substitute the grade used herein.

1. A flexible packaging material comprising:
a sealant web composed of polyethylene and comprising a sealing surface and an opposed lamination surface;
a printing film comprising a hazy polymer layer composed of non-oriented high molecular weight (HMW) high density polyethylene (HDPE), the printing film having an inner surface and an outer surface;
a printable material that is printed onto the inner surface of the printing film prior to lamination of the lamination surface of the sealant web to the inner surface of the printing film thereby sandwiching the printable material therebetween; and
an adhesive disposed in between the sealant web and the printing film for lamination thereof.

2. The flexible packaging material of claim 1, wherein the printing film is a monolayer of the non-oriented high molecular weight (HMW) high density polyethylene (HDPE).

3. The flexible packaging material of claim 2, wherein the printing film has a haze of at least 30%.

4. The flexible packaging material of claim 2, wherein the printing film has a haze of 80% to 90%.

5. The flexible packaging material of claim 2, wherein the hazy polymer layer has a non-oriented HMW-HDPE content of at least 70 wt %, based on the total weight of the hazy polymer layer.

6. The flexible packaging material of claim 2, wherein the printing film has a stiffness between 100,000 and 160,000 psi for the machine direction (MD) secant modulus at 1% measured using ASTM D882.

7. The flexible packaging material of claim 1, wherein the printing film is a coextruded multilayer film comprising:
an external polymeric skin layer contiguous with the hazy polymer layer; and
an internal polymeric skin layer contiguous with the hazy polymer layer, such that the hazy polymer layer is a core layer.

8. The flexible packaging material of claim 7, wherein the internal polymeric skin layer has high gloss properties, the printable material being applied to the internal polymeric skin layer.

9. The flexible packaging material of claim 7, wherein the external polymeric skin layer has high gloss properties, the printable material being applied to the internal polymeric skin layer.

10. The flexible packaging material of claim 7, wherein the internal polymeric skin layer has high haze properties, the printable material being applied to the internal polymeric skin layer.

11. The flexible packaging material of claim 7, wherein the external polymeric skin layer has high haze properties, the printable material being applied to the internal polymeric skin layer.

12. The flexible packaging material of claim 7, wherein the external polymeric skin layer or the external polymeric skin layer, or both, comprise a bimodal medium density polyethylene resin.

13. The flexible packaging material of claim 8, wherein the high gloss properties are provided by medium density polyethylene (MDPE) as the polymeric material.

14. The flexible packaging material of claim 10, wherein the high haze properties are provided by non-oriented HMW HDPE.

15. The flexible packaging material of claim 7, wherein the printing film has a stiffness of 80,000 to 100,000 psi and the sealant web has a stiffness of 50,000 to 80,000 psi, for the machine direction (MD) secant modulus at 1% measured using ASTM D882.

16. The flexible packaging material of claim 1, wherein the sealant web comprises food-grade post-consumer recycled (PCR) material, and wherein the PCR comprises high-density polyethylene (HDPE) and is present in the flexible packaging material in an amount between 20 wt % and 60 wt % based on the total weight of the flexible packaging material.

17. The flexible packaging material of claim 1, wherein the printable material comprises a high oxygen (gas) barrier material, and wherein the gas barrier material is provided in a thickness corresponding to 0.5 to 1.5 lbs/ream.

18. The flexible packaging material of claim 1, wherein the hazy polymer layer comprises a metallocene comprising linear low-density polyethylene (mLLDPE).

19. The flexible packaging material of claim 18, wherein the metallocene is present in the hazy polymer layer in an amount between 1 wt % and 15 wt %, based on the total weight of the hazy polymer layer.

20. The flexible packaging material of claim 1, wherein the hazy polymer layer comprises linear low-density polyethylene (LLDPE), and wherein the LLDPE is present in the hazy polymer layer in an amount between 10 wt % and 45 wt %, based on the total weight of the hazy polymer layer.

21. The flexible packaging material of claim 1, wherein the hazy polymer layer is selected and is present in a quantity sufficient to provide tackiness to the printing film for self-connection at a sealing temperature between 80° C. and 120° C. to form a packaging article.

22. The flexible packaging material of claim 1, wherein the non-oriented HMW-HDPE is present in the hazy polymer layer in an amount of at least 50 wt %, based on the total weight of the hazy polymer layer.

23. The flexible packaging material of claim 1, wherein the printing film is a co-extruded three-layer film with glossy skin layers and the hazy polymer layer is a core layer, and the hazy polymer layer, the glossy skin layers, and the printing film have one of the following thickness properties:
the printing film has a layer ratio that includes the core layer being 50-70% and the glossy skin layers being 15-25%; and
the printing film has a thickness between 1 and 2 mil.

24. The flexible packaging material of claim 1, wherein the printing film is a monolayer of the hazy polymer layer, and the hazy polymer layer has a thickness between 1.25 and 1.5.

25. A flexible packaging material comprising a printing film comprising a hazy polymer layer composed of non-oriented high molecular weight (HMW) high density polyethylene (HDPE), the printing film having an inner surface and an outer surface and being configured to be reverse printed upon and to be laminated with a polyethylene-based sealant web, the hazy polymer layer having a thickness between 0.5 mil and 2.5 mil and a pre-lamination haze above 10%, optionally between 30% and 90% in monolayer or between 10% and 15% when co-extruded with glossy skin layers.

26. A printing film for use in a flexible packaging material to provide a matte finish, comprising a hazy polymer layer composed of non-oriented high molecular weight (HMW) high density polyethylene (HDPE), the printing film having an inner surface and an outer surface and being configured to be printed upon and to be laminated with a polyethylene-based sealant web, the printing film having a thickness between 0.5 mil and 2.5 mil and a haze of at least 30%.
